(19) United States
(12) Patent Application Publication
(10) Pub. No.: US 2012/0069599 A1
(43) Pub. Date: Mar. 22, 2012

(54) TRANSPARENT LUMINOUS WINDOW

(75) Inventors: Hugo Johan Cornelissen, Eindhoven (NL); Gerrit Oversluizen, Eindhoven (NL); Jan Frank Strömer, Eindhoven (NL)

(73) Assignee: KONINKLIJKE PHILIPS ELECTRONICS N.V., Eindhoven (NL)

(21) Appl. No.: 13/321,179

(22) PCT Filed: May 18, 2010
(86) PCT No.: PCT/IB2010/052204

§ 371 Date: Nov. 18, 2011

(30) Foreign Application Priority Data
May 28, 2009 (EP) 09161376.0

(51) Int. Cl. F21V 8/00

(52) U.S. Cl. 362/613; 362/611

(57) ABSTRACT

The invention relates to a luminous window which can function both as a broad area light source and as a transparent window. The broad area light source is achieved by coupling light into a plate-shaped light guide, e.g. via the edges of the light guide, and extracting light from the light guide using geometric protrusions or diffraction gratings into a scattering layer which outputs the broad area light. The transparent window is achieved by switching the scattering layer into a non-scattering state, and possibly switching off the light source, so that light can propagate freely through the light guide and the scattering layer.

### FIELD OF THE INVENTION

The present invention relates to a luminous window and in particular to a luminous window which has a transparent mode.

### BACKGROUND OF THE INVENTION

Flat panel displays, for example liquid crystal displays and plasma display panels have found its inroad into the living room of many households. When the display is turned off, is would be desirable to be able to hide the display, since in the off state the display only shows a large dark area. Accordingly, there is a desire to make the display less obtrusive.

Attempts have been made to hide the display by arranging a switchable scattering window in front of the display. When the display is not used for watching images, the scattering layer is set in a scattering mode to scatter light so as to make the display more or less invisible. When the display is used for watching images, the scattering layer is set in a transparent mode to allow light from the display to propagate through the scattering layer without being scattered. However, it is a problem that the scattering layer is not capable of hiding the display as much as desired. Therefore, it would be desirable to provide a solution which offers improved hiding capabilities.

### SUMMARY OF THE INVENTION

Accordingly, the invention preferably seeks to alleviate or eliminate problems of using a scattering window for hiding a television display and possibly other objects. In particular, it may be seen as an object of the present invention to provide a window that solves the above mentioned problems of the prior art with limited hiding capabilities.

This object and several other objects are obtained in a first aspect of the invention by providing a luminous window device comprising:
a light guide formed as a plate having first and second faces and provided with at least one non-scattering light extracting feature on at least one of the faces,
a light source arranged for coupling light into the light guide,
a scattering layer arranged adjacent to one of the faces of the light guide and being switchable between transparent and scattering states.

The invention is particularly, but not exclusively, advantageous for obtaining a window capable of hiding television displays and possibly other objects such as commercial signs. This advantage may be achieved by the combination of a light guide with non-scattering features and a scattering layer. When the scattering layer is in the scattering state, light extracted by the light extracting features is scattered by the scattering layer so that the luminous window may function as a large area light source capable of hiding e.g. a flat panel display. In addition, the broad area light source not only hides an object, but may also provide atmosphere lightning. By switching the scattering layer to the non-scattering state and switching off the light source, the luminous window may function as a transparent window which is substantially invisible since the light extracting features are non-scattering light extracting features which substantially does not modify light rays propagating through the light guide. Thus, it may be seen as an advantage that the luminous window provides dual modes of operation depending on the scattering state of the scattering layer.

In an embodiment, the light guide may be configured to distribute light from the light source or a plurality of light sources in the volume formed between the first and second faces and where the at least one non-scattering light extracting feature is provided to output at least a fraction of the distributed light through at least part of at least one of the first and second faces. The light guide may be formed as a plate-shaped body defined by the first and second large area faces and by the edges between the faces. The faces and the edges define a volume wherein light is spread to obtain a uniform distribution of light. The one or more light extracting features provided on at least one of the faces extracts and outputs light in direction of an adjacent face of the light scattering layer.

In an embodiment the non-scattering light extracting feature may be configured to extract rays by refracting or diffracting light rays. It may be advantageous to extract light use of refracting or diffracting light extracting features since such features does not scatter light and, therefore, maintains transparency.

In an embodiment the non-scattering light extracting feature may be angled, at least locally, so as to reduce the angle of incidence as compared to a face of the light guide which is not provided with a light extracting feature. By providing a reduced angle, at least locally, at one of the faces of the light guide, in the form of a light extracting feature, it is possible to extract light rays which would otherwise be internally reflected. Thus, light extracting features which are angles enables improved light extracting capabilities. The reduced angle may be provided locally, on bounded areas at one of the faces, or the reduced angle may extend to the entire area of the surface.

In an embodiment a plurality of light extracting features may be shaped by non-constant slopes so as to increase spreading of light from the light source within the light guide. Thus, by varying angles of the light extracting features the uniformity of the extracted and outputted light may be improved.

In an embodiment at least some of the non-constant slopes may be angled, at least locally, so as to reduce the angle of incidence as compared to a face of the light guide which is not provided with a light extracting feature. Thus, by reducing the angle of incidence of a plurality of the light extracting features, light extraction may be improved simultaneously with improvement of light spreading within the volume of the light guide.

In an embodiment the non-scattering light extracting feature may be a diffraction grating configured to diffract light rays from the light source by diffracting only light rays having an angle of incidence with respect to the diffraction grating being greater than an angular threshold determined by the pitch of the diffraction grating. It may be advantageous to use diffraction based light extraction features, since such features maintains transparence when the diffraction gratings only diffracts rays impinging the grating at low angles of incidence whereas rays impinging a large angles of incidence are transmitted without being diffracted.

In an embodiment the pitch of the grating may be in the range from 200 to 400 nanometers to improve transparency of the grating. It may be particularly advantageous to apply a grating with a pitch in the range from 240 to 275 nano meters to improve extraction of all colors of the light from the light source.

In an embodiment the first and second faces may be provided with first and second light extracting features, where the first light extracting feature is configured to extract light rays propagating in a first direction and the where the second light extracting feature is configured to extract light rays propagating in a second direction being different from the first direction. By providing light extracting features on both faces and oriented to extract light from ray propagating in different directions, e.g. perpendicular directions, uniformity of outputted light may be further improved.

In an embodiment the first and second light extracting features may be first and second diffraction gratings. It may be advantageous to provide diffraction gratings on both faces in order to improve uniformity of outputted light.

In an embodiment the light guide may be provided with in-coupling means shaped to increase spreading of light from the light source within the light guide. The in-coupling means may be provided on an edge of the light guide. For example, the edge may be formed as a curved surface to form a cylindrical lens for improving spreading of light within the light guide.

A second aspect of the invention relates to a display apparatus comprising,
a luminous window according to the first aspect, and
a display facing the luminous window.

It may be advantageous to combine a display, such as a flat panel television display, with luminous window, since the window is capable of hiding the television display when it is not in use for showing images.

A third aspect of the invention relates to mirror device comprising,
a luminous window according to the first aspect,
a mirror surface facing the luminous window.

It may be advantageous to combine a mirror, such as a bath room mirror, with a luminous window, since the luminous window is capable of changing the mirror into a large area light source, for example when the mirror is not intended to be used as a mirror.

An embodiment of the display apparatus according to the second aspect may further comprise a polarizing layer between the luminous window and the display for transmission of polarized light radiated by the display and for reflection of at least part of un-polarized light propagating towards the display. It may be advantageous to arrange a polarizing layer between the window and the display in order to enable a semi-transparent mirror appearance of the display. The polarizing layer may be a reflective polarizer capable of transmitting one polarization while reflecting other polarization directions.

A fourth aspect of the invention relates to a method for generating a broad-area light field comprising:
providing a light guide formed as a plate having first and second faces and provided with at least one non-scattering light extracting feature on at least one of the faces,
coupling light from a light source into the light guide, and
providing a scattering layer arranged adjacent to one of the faces of the light guide, and being switchable between transparent and scattering states.

The first, second, third and fourth aspect of the present invention may each be combined with any of the other aspects. These and other aspects of the invention will be apparent from and elucidated with reference to the embodiments described hereinafter.

### BRIEF DESCRIPTION OF THE FIGURES

The present invention will now be explained, by way of example only, with reference to the accompanying Figures, where

FIG. 1A shows a side view of a luminous window in its luminous state,

FIG. 1B shows a side view of a luminous window in its transparent state,

FIGS. 2A-E show different light extracting features formed as protrusions of one of the faces of the light guide,

FIG. 3 shows a light extracting feature in the form of a diffraction grating,

FIG. 4 shows use of light extracting features on both faces of a light guide, and

FIGS. 5A-C shows applications of the luminous window to form an image display in FIG. 5A, a mirror device in FIG. 5B, and an image display with a semitransparent mirror in FIG. 5C.

### DETAILED DESCRIPTION OF AN EMBODIMENT

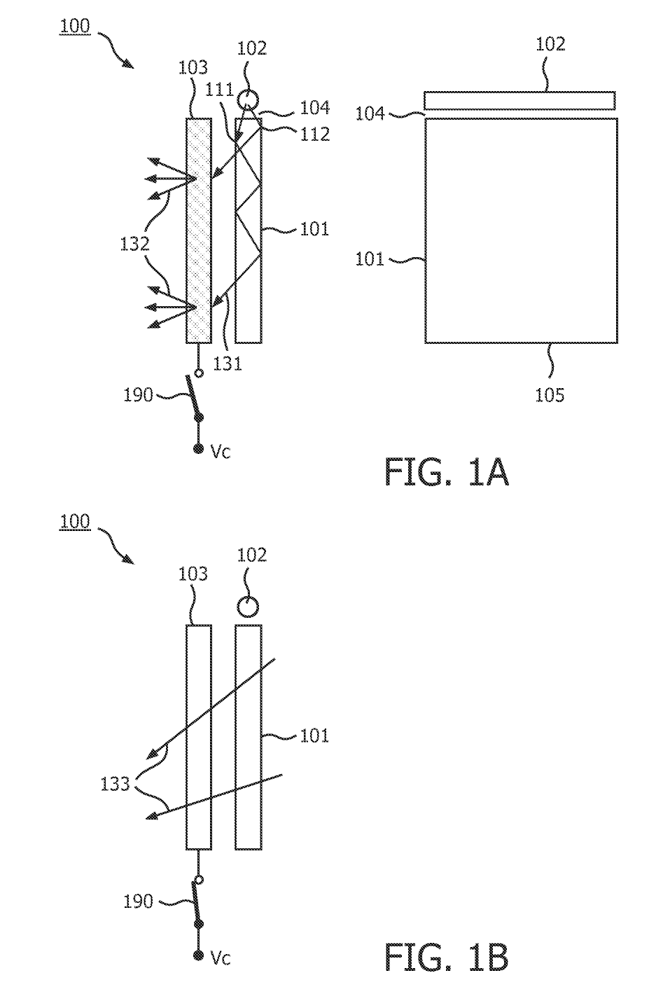

FIG. 1A shows a side view of a luminous window 100 comprising a light guide 101, a light source 102 arranged to couple light into the light guide 101, and a switchable scattering layer 103. The right side of FIG. 1A which shows a top view of the luminous window 100 with the light guide facing the viewer illustrates that the light guide 101 generally is shaped as a plate having first and second faces 111 and 112.

The scattering layer 103 is dimensioned to partly or fully cover one of the faces 111,112 of the light guide. The scattering layer 103 may be a plate being optically connected to the light guide, i.e. using optically transparent adhesive, or otherwise connected to the light guide so that an air gap exists between the adjacent faces of the light guide and the scattering layer as shown in FIG. 1A.

The light source 102 may be a single light source such as a Light Emitting Diode (LED), or an array source 102 comprised by a plurality of LEDs extending along one of the edges 104 of the light guide as shown in the top view in FIG. 1A. Preferably, the light from the light source is coupled into the light guide 102 via one of the edges 104. However, the light could also be coupled into the light guide via corners 105 of the light guide.

The light guide 101 is provided with a least one non-scattering light extracting feature (not shown) on one of the faces 111,112 or on both faces. The non-scattering light extraction feature serves to extract light propagating in the light guide into output light rays 131. In contrast, scattering light extraction features extract light by scattering features provided on one of the faces 111,112. In comparison, the scattering features make the light guide 101 non-transparent, whereas the non-scattering features makes the light guide 101 transparent.

The light guide 101 and the non-scattering light extraction features may be made of the same material, for example glass or transparent polymer.

The scattering layer 103 is switchable between transparent and scattering states. Switching between the states may be achieved by switching a voltage Vc applied to the scattering layer by a switch 190. In the scattering state the scattering layer 103 scatters light that propagates into the scattering layer, whereas in the transparent state, light that propagates into the scattering layer is transmitted through the layer. For example a light ray 131 transmitted from the light guide into the scattering layer will be scattered into scattered light 132 when the scattering layer is the scattering state.

FIG. 1B illustrates that when the scattering layer is in the transparent mode, light rays 133, for example generated by a display or monitor (not shown), is transmitted through the scattering layer, substantially without being scattered or otherwise affected by the scattering layer.

The scattering layer 103 may be a polymer-dispersed liquid crystal consisting of liquid crystal molecules dispersed in a solid transparent material. By changing the orientated of the liquid crystal molecules using a electric field Vc, the liquid crystal molecules can be switched into a first state where the molecules scatters light and into a second state where they do not affect propagation of light.

Due to the combination of a switchable scattering layer 103 and the non-scattering light extracting features the luminous window serves two function: 1) When the scattering layer is in the scattering state, the window serves a luminous window or a broad area light source, where the light from the light source 102 is distributed in the light guide 101, outputted by the light extracting features towards the scattering layer 103 and finally scattered out from the scattering layer. 2) When the scattering layer is in the transparent state, the luminous window serves as a transparent window where light from either side of the window is transmitted through the window without being distorted or scattered.

Accordingly, an object or image placed on either side of the window is clearly visible through the window in the transparent state whereas the object or image is invisible or at least only partly visible through the window in the scattering state.

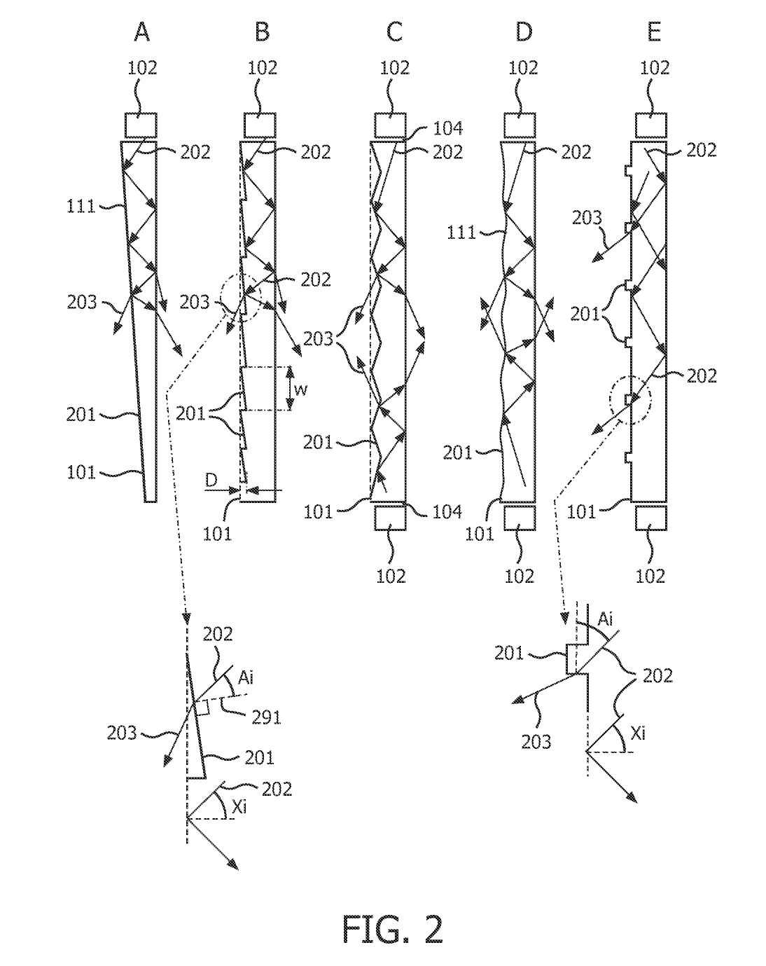

FIGS. 2A-E shows light guides 101 with different configurations of non-scattering light extracting features 201 for extraction of light by refraction.

FIG. 2A shows a light guide 101 with a single light extracting feature 201 in the form of a wedge shaped light guide.

FIGS. 2B-D shows light guides 101 with a plurality of light extracting features shaped by non-constant slopes. In FIG. 2B the slopes of the wedge-shaped light extracting protrusions 201 gradually changes, e.g. increases, along the main propagation direction of the light source 102. In FIG. 2C the slopes of the protrusions 201 alternates between positive and negative slopes. In FIG. 2D the light extracting protrusions 201 are formed by a wavy pattern such as a sinusoidal pattern so that slopes of the light extracting features varies continuously. The non-constant or varying slopes of the light extracting protrusions 201 helps to spread light from the light sources 102 within the volume of the light guide 101, i.e. to obtain a uniform light intensity within the light guide, so that the light refracted through the first face 111 ensures a uniform light intensity over the area of the first face 111.

FIG. 2E shows a light guide 101 with a plurality of light extracting features in the form of micro ridges such as rectangular-shaped protrusions.

When the light guide is provided with a symmetric pattern of light extracting protrusions as shown in FIGS. 2C-E, uniformity of the light distribution within and outside the light guide can be improved by coupling light into the light guide from light sources 102 arranged at opposite edges 104. Thus, the counter propagating light rays coupled into opposite sides of the light guide from the oppositely arranged light sources 102 passes the pattern of light extracting features. Uniformity of light distribution may also be improved by injecting light into opposite edges 104, when the light extracting feature is formed by a single wedge as shown in FIG. 2A or by a non-symmetric pattern as shown in FIG. 2B, possibly by adapting in-coupling of light, i.e. by controlling spreading of light from the light sources, for example by lens-shaping the edges of the light guide to properly spread light within the light guide. The light extracting features 201 in FIGS. 2A-2E are angled so as to reduce the angle of incidence Ai between the surface normal 291 and the impinging ray 202 from the light source (see the enlarged views of protrusions of FIGS. 2B, 2D in FIGS. 2F, 2G, respectively). That is, the angle of incidence Ai is reduced as compared to the angle of incidence Xi with respect to a light guide which is not provided with light extracting features 201, or in other words, a light guide with a non-angled first face 111. Thus, the angled light extracting feature 201 allows the impinging light ray 202 to be extracted and outputted as a refracted ray 203, whereas a non-angled first face 111 would cause the same impinging ray 202 to be exposed to total internal reflection.

The longitudinal dimension w of the protrusions 201 in FIGS. 2B-E may be within the range from 50 to 750 micro meters, for example between 150 and 250 micrometer. The depth d of the protrusion 201 may be within the range from 1 to 10 micro meters, for example between 2 and 4 micro meters. Accordingly, the slopes of the protrusions range between 0.001 and 0.2 radians. In general the dimensions of the geometric protrusions should be larger than the wavelength of visible light in order to avoid diffraction effects. Due to the low slopes of the light extracting features 201, the light guides have the substantially the same transparency as a normal window. Therefore, image distortion of an image being viewed through the luminous window 101 is minimized as compared to a light guide with scattering-dot extraction features—when the luminous window is in the transparent state.

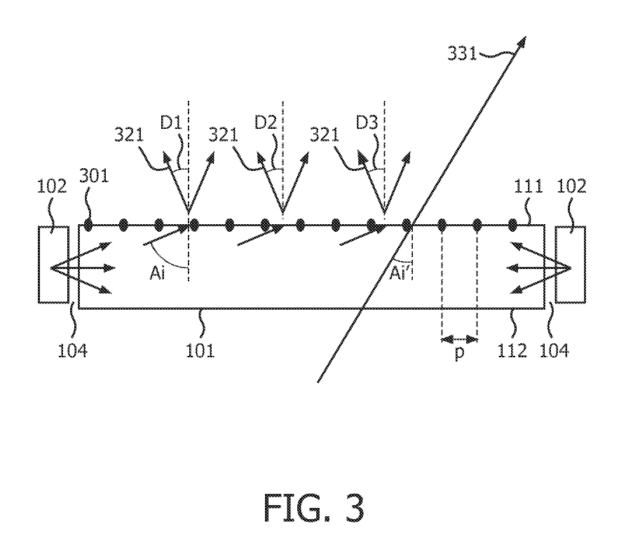

FIG. 3 shows a light guide 101 with non-scattering light extracting features 201 in the form of diffraction grating 301 for extraction of light by diffraction. The diffraction gratings are provided on the first face 111 of the light guide. To maintain transparency of the light guide provided with diffraction grating 301, the pitch p of the diffraction grating is chosen so as to diffract only light rays from the light source 102 having an angle of incidence Ai with respect to the face 111 with the diffraction grating 301 being greater than a given threshold. The threshold of the angle of incidence is determined by the pitch p of the diffraction grating 301. A pitch in the range from 200 to 400 nano meters is appropriate to maintain transparency of the light guide. A pitch in the range from 240 to 275 nano meters has proven to be appropriate to extract all colors of the emitted light simultaneously from the lightguide and maintaining transparency. Since only light rays with large angles of incidences Ai are diffracted, light rays 331 with angles of incidences Ai′ less than the threshold are transmitted un-diffracted through the light guide meaning that transparency is optimal for light rays with angles of incidence greater than the threshold angle. Since the diffraction grating is symmetric, uniformity of the light distribution within and outside the light guide can be improved by coupling light into the light guide from light sources 102 arranged at opposite edges 104.

Light is diffracted from the light guide 101 into rays 131 with different diffraction angles D1-D3 and respective different wavelengths L1-L3. Clearly, if the light guide was used as a luminous window without a scattering layer 103, the luminous window or broad area source would diffract light in different colors in different directions. However, due to the scattering layer 103 the different colors of the diffracted light will mix in the scattering layer so that light outputted from the scattering layer will have the same color irrespective of a person's viewing angle.

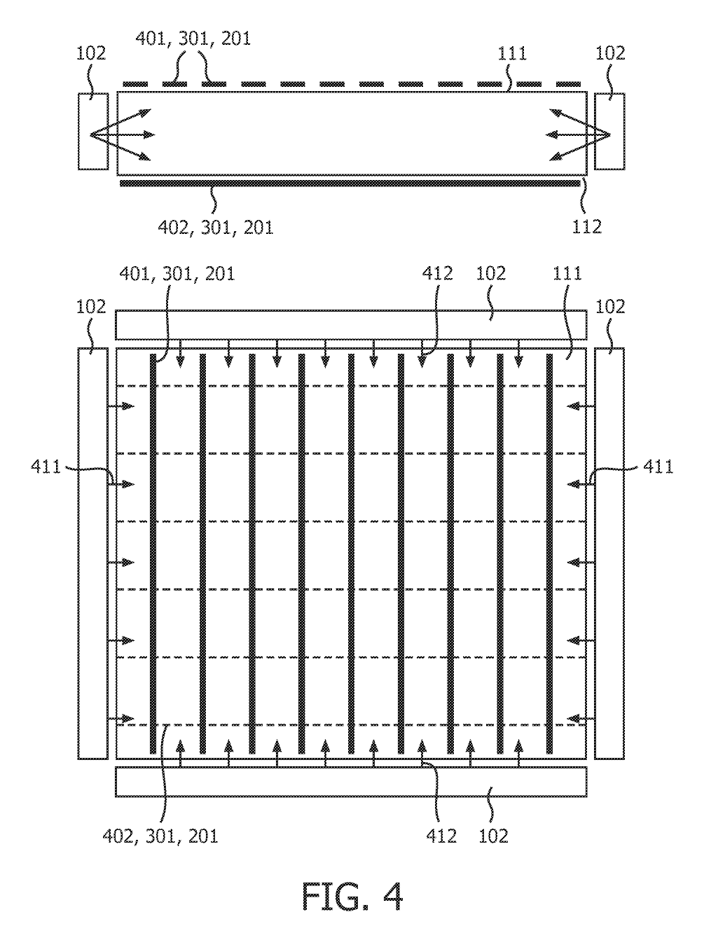

FIG. 4, top, shows a side view of a light guide where the first and second faces 111,112 are provided with respective first and second light extracting features 401,402. The first and second light extracting features 401 and 402 may both be geometrical light extracting features as shown in FIGS. 2A-E or diffraction based light extracting features as shown in FIG. 3. Alternatively, one of the first and second faces may be provided with geometrical light extracting features and the other face may be provided with diffraction based light extracting features.

FIG. 4, bottom, shows a top view of the same light guide with first and second light extracting features 401,402. The first light extracting feature 401 could be arranged to extract light from a first light source 421 or a first couple of light sources 421 generating light propagating in a first direction 411. Similarly, the second light extracting feature 402 could be arranged to extract light from a second light source 422 or a second set of light sources 422 generating light propagating in a second direction 412.

By use of light sources which generates light propagating in different directions, uniformity of the distributed light within the light guide 101 can be improved further. Also, use of light sources arranged at more than two edges 104, for example all four edges of a square light guide 101, enables generation of a higher a light intensity.

As illustrated in FIG. 4, bottom, the first light extraction features 401, e.g. protrusions 201 or diffraction lines 301, extends in a direction perpendicular to the first light direction 411. Similarly, the second light extraction feature 402 extends in a direction perpendicular to the first extraction features 401 and perpendicular to the second light direction 412. It is understood that extensions of first and second light extraction features do not necessarily need to be perpendicular to each other, but may have other relative angles.

In order to improve spreading of light within the light guide for achieving a more uniform light intensity of the extracted light, the edges of the light guide may be shaped, instead of being plane, so as to increase spreading of light. The edges of the light guide may for example be shaped as a concave or convex lens surface.

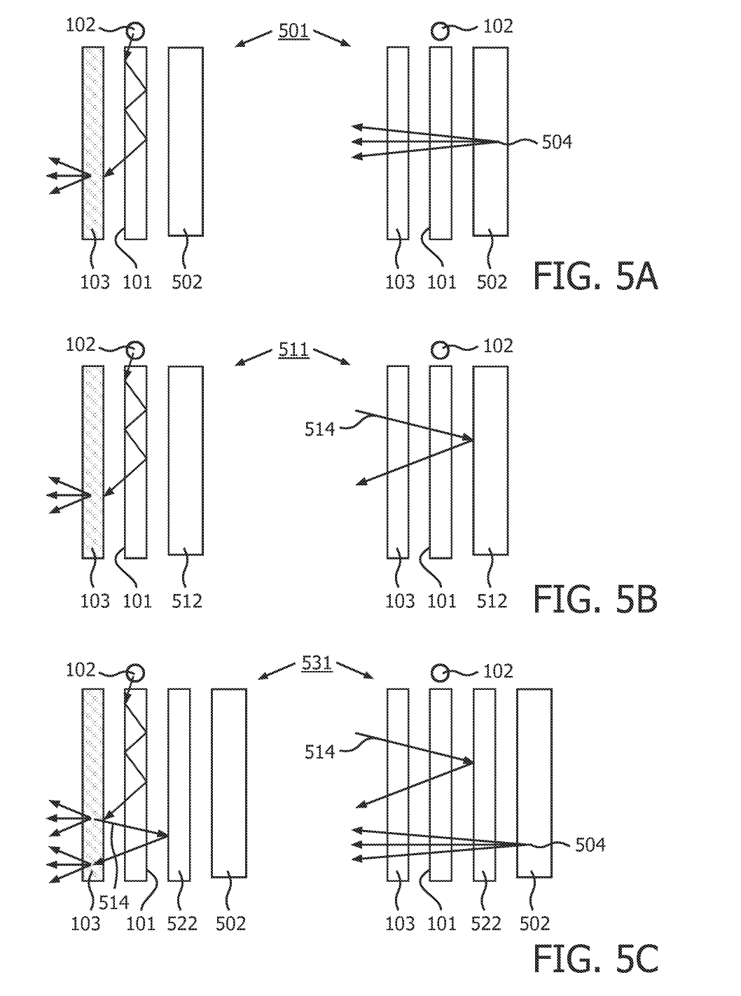

FIG. 5A-C shows different applications of the luminous window.

FIG. 5A shows a display apparatus 501 comprising the luminous window 100—comprised by the light guide 101, the light source 102 and the switchable scattering layer 103—and a LCD monitor 502 or other electronic image displaying devices such as advertising signs. On the figure to the left, the display apparatus 501 functions as a large area light source when the light source 102 is on and the scattering layer 103 is in the scattering layer. Thus, in this state the display apparatus provides an atmosphere providing light source which furthermore hides the dark and unpleasant monitor 502. When the display apparatus is to be used to view images presented on the monitor 502, the light source 102 is switched off and the scattering layer is switched to its non-scattering state as shown in the figure to the right. Light rays 504 from the monitor are transmitted unaffected through the light guide 101 and the scattering layer 103.

FIG. 5B shows a mirror device 511 comprising the luminous window 100—comprised by the light guide 101, the light source 102 and the switchable scattering layer 103—and a mirror 512 such as a bathroom mirror. On the figure to the left, the mirror device 511 functions as a large area light source when the light source 102 is on and the scattering layer 103 is in the scattering layer. On the figure to the right, the mirror device 511 function as a normal mirror where light rays 514 are reflected by the mirror 511 without being distorted by the light guide 101 and the scattering layer 103.

FIG. 5C shows an alternative display apparatus 531 comprising the luminous window 100—comprised by the light guide 101, the light source 102 and the switchable scattering layer 103—and a polarizing layer 522 and a LCD monitor 502. The polarizing layer 522 reflects un-polarized light and transmits light that is polarized in the polarization direction of the polarizing layer 522. Thus, when the display apparatus 531 is in the display state—where the scattering layer is switched to its non-scattering state and the light source 102 is switched off—polarized light 504 from the monitor 502 is transmitted through the polarizing layer 522 and the luminous window 100, whereas external un-polarized light rays 514 are reflected by the polarizing layer. Thus is this state the display apparatus provides a semi-mirror mode. When the display apparatus 531 is in the luminous state—where the scattering layer is switched to its scattering state and the light source 102 is switched on—the polarizing layer 522 serves to increase luminaire brightness since scattered light rays 541 from the scattering layer is reflected by the polarizing layer and scattered once more by the scattering layer.

In any of the display apparatus 501, the mirror device 511 and the alternative display apparatus 531, the order of the scattering layer 103 and the light guide 101 may be reversed so that the scattering layer faces the monitor 502, the mirror 512 or the polarizing layer 522.

In summary the invention relates to a luminous window which can function both as a broad area light source and as a transparent window. The broad area light source is achieved by coupling light into a plate-shaped light guide, e.g. via the edges of the light guide, and extracting light from the light guide using geometric protrusions or diffraction gratings into a scattering layer which outputs the broad area light. The transparent window is achieved by switching the scattering layer into a non-scattering state, and possibly switching off the light source, so that light can propagate freely through the light guide and the scattering layer.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A luminous window device (100) comprising:
a light guide (101) formed as a plate having first and second faces (111,112) and provided with at least one non-scattering light extracting feature (201,301) on at least one of the faces,
a light source (102) arranged for coupling light into the light guide (101),
a scattering layer (103) arranged adjacent to one of the faces (111,112) of the light guide and being switchable between transparent and scattering states.

2. A device according to claim 1, where the light guide (101) is configured to distribute light from the light source (102) or a plurality of light sources in the volume formed between the first and second faces (111,112) and where the at least one non-scattering light extracting feature (201,301) is provided to output at least a fraction of the distributed light through at least part of at least one of the first and second faces.

3. A device according to claim 1, where the non-scattering light extracting feature (201,301) is configured to extract rays by refracting or diffracting light rays.

4. A device according to claim 1, where the non-scattering light extracting feature (201) is angled, at least locally, so as to reduce the angle of incidence (Ai) as compared to a face (111) of the light guide which is not provided with a light extracting feature.

5. A device according to claim 1, where a plurality of light extracting features (201) are shaped by non-constant slopes so as to increase spreading of light from the light source (102) within the light guide (101).

6. A device according to claim 5, where at least some of the non-constant slopes are angled, at least locally, so as to reduce the angle of incidence (Ai) as compared to a face (111) of the light guide which is not provided with a light extracting feature.

7. A device according to claim 1, where the non-scattering light extracting feature (301) is a diffraction grating configured to diffract light rays from the light source (102) by diffracting only light rays having an angle of incidence (Ai) with respect to the diffraction grating being greater than an angular threshold determined by the pitch (p) of the diffraction grating.

8. A device according to claim 7, where the pitch (p) of the grating is in the range from 200 to 400 nanometers.

9. A device according to claim 1, where the first and second faces (111,112) are provided with first and second light extracting features (401,402), where the first light extracting feature (401) is configured to extract light rays propagating in a first direction (411) and the where the second light extracting feature (402) is configured to extract light rays propagating in a second direction (412) being different from the first direction.

10. A device according to claim 9, where the first and second light extracting features (401,402) are first and second diffraction gratings.

11. A device according to claim 1, where the light guide is provided with in-coupling means shaped to increase spreading of light from the light source within the light guide.

12. A display apparatus (501) comprising,
a luminous window (100) according to claim 1,
a display (502) facing the luminous window.

13. A mirror device (511) comprising,
a luminous window (100) according to claim 1,
a mirror surface (512) facing the luminous window.

14. A display apparatus according to claim 12, further comprising a polarizing layer (522) between the luminous window (100) and the display (502) for transmission of polarized light (504) radiated by the display and for reflection of at least part of un-polarized light (514) propagating towards the display.

15. A method for generating a broad-area light field comprising:
providing a light guide (101) formed as a plate having first and second faces (111,112) and provided with at least one non-scattering light extracting feature (201,301) on at least one of the faces,
coupling light from a light source (102) into the light guide (101), and
providing a scattering layer (103) arranged adjacent to one of the faces (111,112) of the light guide and being switchable between transparent and scattering states.
